(19) United States
(12) Patent Application Publication
(10) Pub. No.: US 2009/0243411 A1
(43) Pub. Date: Oct. 1, 2009

(54) Transmission Systems of Continuously Variable Transmission Ratio

(76) Inventor: Frank H. Moeller, Stafford (GB)

Correspondence Address: ABELMAN, FRAYNE & SCHWAB, 666 THIRD AVENUE, 10TH FLOOR, NEW YORK, NY, 10017, US

(21) Appl. No.: 12/373,503

(22) PCT Filed: Jul. 13, 2007
(86) PCT No.: PCT/GB2007/002658

§ 371 Date: Mar. 11, 2009

(30) Foreign Application Priority Data
Jul. 14, 2006 (GB) 0614084.2

(51) Int. Cl. H02K 16/00; F16H 48/06; H02K 21/24

(52) U.S. Cl. 310/90; 475/220; 310/114

(57) ABSTRACT

A transmission system with continuously variable transmission ratio includes an input shaft (2), an output shaft (4) and preferably also a differential gearset comprising at least three parallel shafts (2, 4, 12). The system also includes first and second motor/generators comprising first and second rotors (16, 32) and first and second stators (20, 26; 36, 26), respectively. The first and second rotors (16, 32) are connected to respective shafts. The electrical connections of the first and second stators are connected together. A controller (45) is arranged to control the flow of electrical power between the first and second stators. At least a portion (26) of the first stator is connected to at least a portion (26) of the second stator. The said portion (26) is movable in a first direction, thereby increasing the air gap of the first motor/generator and decreasing the air gap of the second motor/generator, and in a second direction, thereby decreasing the air gap of the first motor/generator and increasing the air gap of the second motor/generator. An actuator (42), which is controlled by the controller (45), is connected to the said portion (26) of the stator to move it selectively in the first or second direction.

The present invention relates to transmission systems of continuously variable transmission ratio, particularly though not exclusively for automotive use, and is concerned with that type of transmission system which includes first and second electric motor/generators comprising first and second rotors and first and second stators, respectively, the first and second rotors being connected to rotate with respective shafts and the electrical connections of the first and second stators being connected together, and a controller arranged to control the flow of electrical power between the first and second stators. The invention is particularly concerned with that type of such transmission system which additionally includes a differential gearset comprising at least three parallel shafts, two of which constitute the input shaft and output shaft, respectively, and all of which carry at least one gearwheel in mesh with at least one gearwheel carried by one of the other shafts.

A transmission system of this type is disclosed in WO2003/047897 and WO2004/088168, which disclose transmission systems for the main propulsive drive of a motor vehicle, and in WO2004/072449, which discloses a transmission system for driving an automotive supercharger. As explained in detail in e.g. WO2003/047897, to which reference may be made for further detail, in a transmission system of this type, one of the electrical machines, that is to say the motor/generators, acts as a generator and transfers electrical power to the other machine which acts as a motor. A proportion of the power transmitted by the transmission system is thus transmitted mechanically whilst a further varying proportion, which is typically up to about one-third of the total, is transmitted electrically. Varying the electrical power transmitted between the two machines, which may simply be achieved by varying the speed by means of a known controller of one of the machines, results in the speed of the output varying at constant speed of the input and thus in the gear or transmission ratio of the transmission system altering.

Thus the two electrical machines act at any one time as a motor and a generator, respectively, or as a generator and a motor, respectively, depending on the instantaneous operating conditions at the time and the speed of each machine and the torque produced by or applied to each machine vary within wide ranges. However, when the speed of one machine is high the speed of the other machine is low and thus also when the torque at one machine is high the torque at the other machine is low.

It is known that the efficiency of an electrical machine varies with the size of the air gap, that is to say the distance between the rotor and stator. However, the optimum air gap for any machine depends on its operating conditions and it is found that at high speed/low torque a relatively large air gap is desirable and that at low speed/high torque a relatively small air gap is desirable. In the transmission systems disclosed in the specifications referred to above, the air gap of the two machines is of course fixed and the size of these air gaps is therefore set out at an optimum compromise value taking into account the range of speeds and torques anticipated at each machine. This means in practice that both machines are therefore operating at less than optimum efficiency for the majority of the time. It is therefore an object of the invention to provide a transmission system of the type referred to above whose efficiency is improved by comparison with known transmissions.

As discussed above, the electrical power transferred between the two electrical machines varies as the output speed varies and in practice reaches zero at two different output speeds, referred to as node points. This means that power is transmitted between the two machines at zero output speed which in turn means that the transmission system provides a “geared neutral”, i.e. the output may be stationary when the input is rotating. At the node points of the system, one or other machine is stationary and all the power is transmitted through the system mechanically rather than electrically and this means that electrical losses are at a minimum. It is, therefore, desirable to operate at one or other of the node points for as great a proportion of the overall operating time as possible. At the two node points, one of the machines is stationary but there is nevertheless in practice a substantial torque on it. A considerable amount of power is required to resist this torque and this means that in fact the operating efficiency at the node points is less than could theoretically be achieved. It is therefore a further object of the invention to provide a transmission system which is adapted to operate at one of the node points for a relatively large proportion of its total operation but whose efficiency when doing so is greater than that of the transmission systems disclosed in the prior specifications referred to above.

The above discussion relates primarily to transmission systems of the type including a differential gearset. However, transmission systems of the type referred to above of all electrical type, that is to say with no differential gearset, are also known and the considerations relating to the operating efficiency of the two motor/generators are again generally similar. Such a transmission system, which is used, for instance, on diesel electric trains and increasingly on certain type of hybrid road vehicles, comprises an input shaft, which is connected to the rotor of a first motor/generator and, in use, to the output shaft of an internal combustion engine. The electrical stator connections of the first motor/generator are connected via a controller to the electrical stator connections of a second motor/generator, the rotor of which is connected to the output shaft of the transmission system, which is connected, in use, to the driven wheels of the vehicle. In use, the internal combustion engine drives the first motor/generator as a generator. The controller determines, e.g. from the position of the vehicle accelerator pedal, what electrical power is required by the other motor/generator, which is operated as a motor, and directs that amount of electrical power to it. Any excess electrical power is directed to the vehicle battery to charge it and any shortfall in the electrical power required is taken from the vehicle battery. On deceleration of the vehicle, the second motor/generator acts regeneratively, that is to say acts as a generator, driven by the movement of the vehicle. The power it produces is directed by the controller to the battery to recharge it and/or to the first motor/generator, which operates as a motor and whose output power is fed back to the internal combustion engine, thereby reducing its fuel consumption.

Accordingly, when the vehicle is moving at low speed and under high acceleration, the first motor/generator operates at high speed but relatively low torque whilst the second motor/generator operates at relatively low speed and high torque. However, when the vehicle is moving at high but constant speed, the second motor/generator operates at high speed but low torque whilst the first motor/generator operates at relatively low speed but relatively higher torque. Accordingly, the speed and torque characteristics of the two motor/generators are again complementary and move in opposite directions as the speed and acceleration conditions of the vehicle change.

According to the present invention a transmission system of continuously variable transmission ratio of the type referred to above is characterised in that at least a portion of the first stator is connected to at least a portion of the second stator, that the said portion is movable in a first direction, thereby increasing the air gap of the first motor/generator and decreasing the air gap of the second motor/generator, and in a second direction, thereby decreasing the air gap of the first motor/generator and increasing the air gap of the second motor/generator and that an actuator is provided, which is controlled by the controller and is connected to the said portion of the stators to move it selectively in the first or second direction. The preferred embodiment includes a differential gearset comprising at least three parallel shafts, two of which constitute the input shaft and the output shaft, respectively, and all of which carry at least one gearwheel in mesh with at last one gearwheel carried by one of the other shafts.

It will be appreciated that, if the transmission is of all electric type, the rotors of the two motor/generators will necessarily be connected to the input and output shaft, respectively. If, however, as is preferred, the transmission includes a differential gearset, the rotors of the two motor/generators may be connected to any appropriate two of the shafts.

Thus the transmission system in accordance with the preferred embodiment of the present invention is of the general type disclosed in any of the prior specifications referred to above. The transmission system in all of these documents includes two motor/generators comprising respective rotors and stators and in accordance with the present invention at least a portion of the two stators is connected together and this portion is movable in either of two opposite directions. The motor/generators are so arranged that movement in one direction will increase the air gap of one motor/generator and decrease the air gap of the other whilst movement in the opposite direction will produce the opposite effect. An actuator is connected to the said portion of the stators to move it selectively in one of the two directions. This actuator is under the control of the controller which has a number of inputs including inputs indicative of the output speed of the transmission and the load applied to the input shaft of the transmission. The controller knows the speed of and the torque on each of the motor/generators and, as mentioned above, a high torque on one motor/generator generally means that the other generator is running at a relatively low torque whilst a low torque at one of the motor/generators generally means that the other is running at high torque. In response to the values of the speed and torque of the two motor/generators, the controller issues a signal to the actuator to move the said portion of the stators in one of the two directions so as to increase the air gap of that motor/generator running at low torque/high speed, in order to bring its efficiency closer to the optimum value and this inherently results in a reduction in the air gap of the other motor/generator, which inherently brings it to a value closer to the optimum for operation under high torque/low speed. Thus the optimisation of the air gap for one motor/generator will inherently result also in at least an approximate optimisation of the air gap of the other motor/generator for the conditions under which the two motor/generators are operating.

The two motor/generators may be of radial flux type, that is to say of the type in which the magnetic flux lines extend generally in the radial direction with respect to the shafts of the rotors, or of axial flux type, in which the magnetic flux lines extend generally parallel to the shafts of the two rotors. If the two motor/generators are of radial flux type, whereby the two rotors extend substantially axially and are mounted to rotate about a common axis parallel to the shafts of the transmission system, each stator is preferably of frusto-conical shape and each rotor is of complementary frusto-conical shape and the two rotors are connected together end to end and arranged to be movable in the direction of the axis of the rotor shafts. Due to the fact that it is necessary that movement of the connected stators in one of the two directions will simultaneously increase one air gap whilst decreasing the other, the two stators will necessary taper in opposite directions. The stators may accommodate the rotors and will in this event define respective frusto-conical spaces of decreasing diameter in opposite directions, within which the respective complementary rotors are rotatably received. Alternatively, the two rotors may accommodate the connected stators and in this event the two rotors will define respective frusto-conical spaces of decreasing diameter in opposite directions within which the respective complementary stators are received.

If the two motor/generators are of axial flux type, whereby the two rotors extend radially and are mounted to rotate about a common axis parallel to the shafts, the first stator preferably comprises first and second annular, radially extending stator members on opposite sides of the first rotor and the second stator comprises third and fourth annular, radially extending stator members on opposite sides of the second rotor, the second and third stator members being connected together and constituting a common stator member or wall connected to the actuator. It is therefore inherent that movement of the common stator wall in either direction parallel to the common axis of the rotor shafts will increase the air gap of one motor/generator whilst simultaneously decreasing the air gap of the other.

Whilst a single actuator may be used acting on the common stator member at a single circumferential point, there is a risk that this will result in the common stator wall becoming skewed with respect to the axis of the rotors and it is therefore preferred that at least three actuators are provided acting on the common stator wall at substantially equiangularly spaced positions.

The two rotors will of course afford a plurality of magnetic poles and it is preferred that these are constituted by permanent magnets. It is also preferred that the said connected portion of the two stators is movable between a first position, in which it is in contact with the first rotor and the first rotor is thus locked to it by the magnetic attraction of the permanent magnets on the first rotor to the said portion of the stators, and a second position, in which it is in contact with the second rotor and the second rotor is thus locked to it by the magnetic attraction of the permanent magnets on the second rotor to the said portion of the stators. Whilst it is known to provide an electric machine with a variable air gap, it is believed not to be known to decrease this air gap to zero. If this is done with a rotor whose magnetic poles are constituted by permanent magnets, the attraction between the magnets and the magnetic material of the stator will result in the rotor and the stator becoming connected or locked together, whereby relative movement is then impossible, unless the torque applied reaches a very high value.

The facility in the transmission of the present invention to lock either of the rotors of the motor/generators to the associated stator, that is to say in practice to the said connected portion of the two stators, is of great value under two quite different sets of circumstances. Firstly, if the transmission system is used as the main propulsion system for an automotive vehicle, one or other of the rotors may be locked to its associated stator when the vehicle is stationary and this will effectively immobilise the vehicle. This magnetic locking facility can therefore be used to supplement or replace the conventional hand brake on a motor vehicle. Secondly, if it is desired to maximise operating efficiency of a transmission system of the present invention including a differential gearset, the control system may sense when one of the node points is reached, at which one of the motor/generators is stationary, and then lock the rotor of that motor/generator to the associated stator. The magnetic lock will then provide the necessary reaction to the torque acting on that motor/generator even when it is stationary, as discussed above, thereby obviating the necessity of consuming power to counteract that torque. This will significantly enhance the efficiency of the transmission system when operating at that node point. The torque applied to the output shaft may nevertheless be varied simply by varying the torque applied to the input shaft, e.g. by varying the pressure applied to the accelerator pedal, and the speed of the output shaft may similarly be varied. Accordingly, when used as a main propulsion transmission for a motor vehicle, the transmission system may be retained at a node point for an extended period of time, thereby reaping the benefit in efficiency described above when operating at the node point. However, if operation of the transmission system should move by a predetermined amount away from what would be node point operation if one of the rotors were not locked to its associated stator, the magnetic lock between the rotor and stator can be released and normal operation is then resumed.

The permanent magnets used in the rotors of electrical machines used in a transmission system of this type are extremely powerful. The number of permanent magnets used may vary but a typical number is twelve. The force required to break the lock between twelve such powerful permanent magnets and the soft iron of the stator is very considerable and breaking the magnetic lock therefore constitutes a significant potential problem. However, in accordance with a further preferred feature of the present invention, the control system is programmed to determine the angular position of each rotor, when in the locked position, relative to the associated stator and then to energise selected electromagnetic coils in the associated stator appropriately to produce a sufficient repulsive force on the rotor that the magnetic lock is released. Normal operation of that motor/generator may then be resumed. The coils which are energised are those which are in any event provided in order to create the electromagnetic poles which are needed on the stator. If there are twelve magnetic poles on the rotor, there are typically nine electrical poles on the stator. It is a simple matter for the control system to determine the relative position of the rotor relative to the stator and this may be done either with the aid of a sensor, e.g. a Hall-effect sensor integrated into the rotor or by detecting the effect on the electrical poles created by the magnetic poles on the rotor.

If it is necessary or desirable to increase the strength of the magnetic lock between one of the rotors and the associated stator, the control system may be programmed to determine the angular position of each rotor, when in the locked position, relative to the associated stator and to energise selected electromagnetic coils in the associated stator appropriately to produce an attractive force on the rotor, thereby enhancing the magnetic attraction between the rotor and stator.

Thus the air gaps of the two electrical machines in the transmission system in accordance with the present invention are continuously adjusted by the controller and one or more associated actuators in order to maintain them at a value which is closer to the optimum for the conditions under which they are operating at any particular moment than when using a constant compromise value for the two air gaps, as in the prior specifications referred to above. Furthermore, the possibility of magnetically locking either of the rotors to its associated stator provides the possibility of operating the transmission system at one or other of the node points for a relatively large proportion of all of the operating conditions under which the transmission system will operate, thereby benefiting from the increased efficiency which is obtained at the node points. The efficiency increase is further enhanced by the fact that it is the magnetic lock which provides the necessary reaction to the torque applied to the stationary rotor, thereby obviating the necessity of unnecessary power consumption in resisting this torque. The overall operating efficiency of a transmission system in accordance with the invention is therefore substantially enhanced by comparison with the known transmission systems of this type.

Further features and details of the present invention will be apparent from the following description of certain specific embodiments which is given by way of example only with reference to the accompanying drawings, in which:

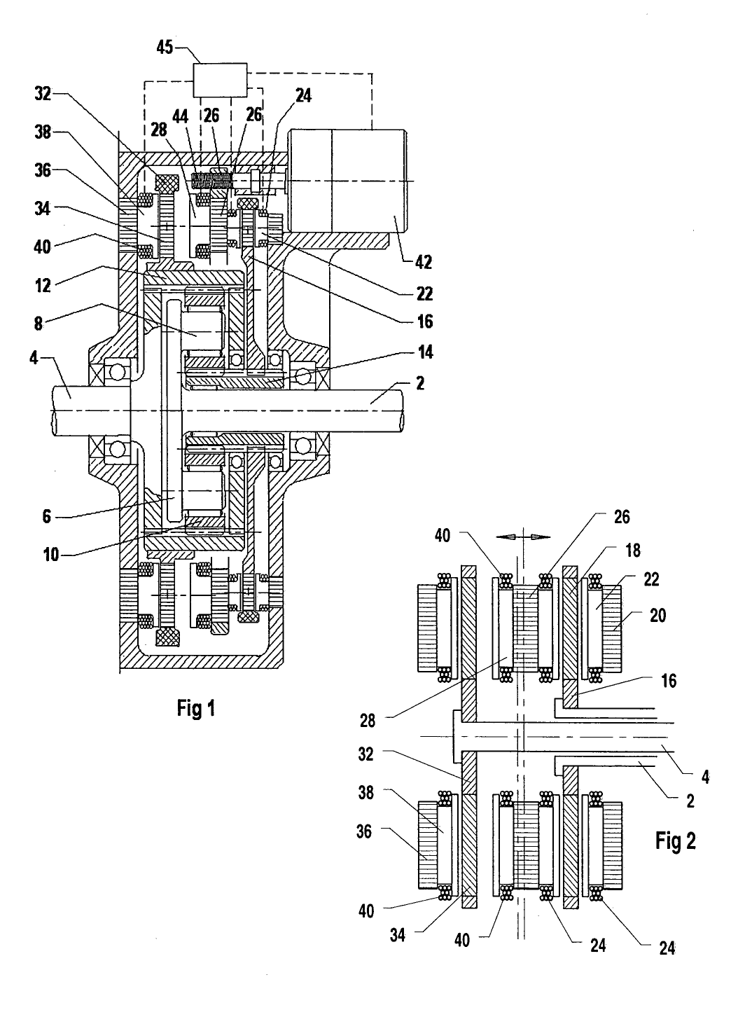

FIG. 1 is an axial sectional view of a transmission system in accordance with the invention including a three-branch epicyclic gearset;

FIG. 2 is a diagrammatic view of a second embodiment of transmission system of the type including no epicyclic gearset;

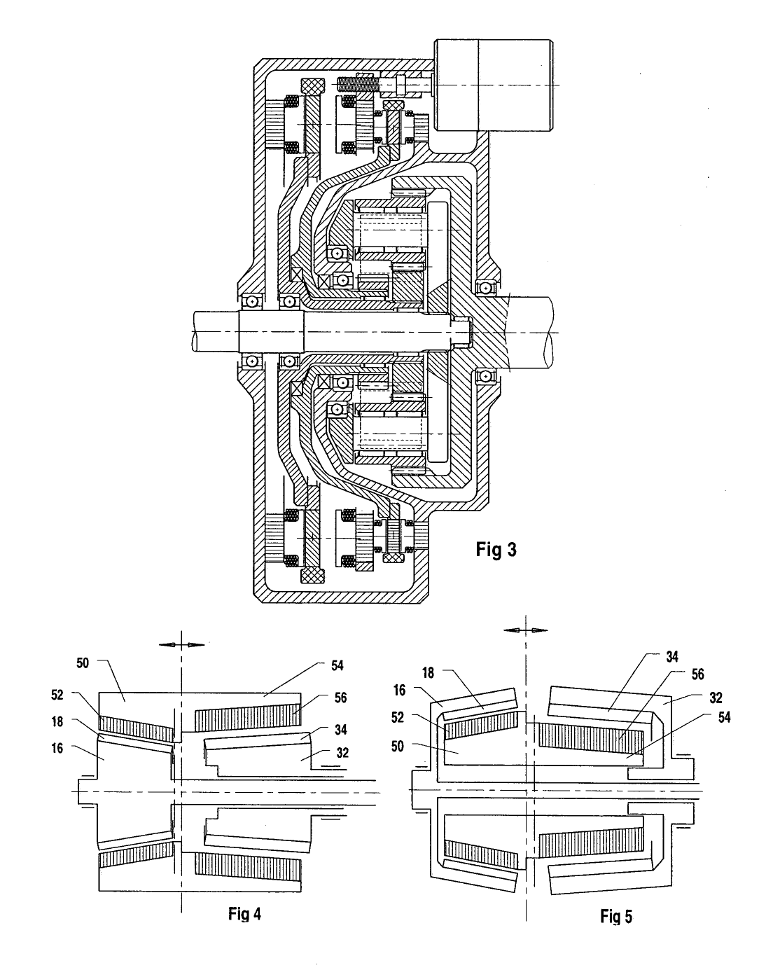

FIG. 3 is a view similar to FIG. 1 of a third embodiment in which the transmission system includes a four-branch epicyclic gearset;

FIG. 4 is a diagrammatic view of the rotors and stators only of a fourth embodiment in which the electrical machines are of radial flux type; and

FIG. 5 is a view similar to FIG. 4 of a fifth embodiment in which the electrical machines are again of radial flux type.

Referring firstly to FIGS. 1 and 2, the transmission system includes an input shaft 2 and an output shaft 4. The input shaft 2 is connected to the carrier 6 of an epicyclic gearset which carries a number, in this case four, of planet shafts 8, each of which rotatably carries a respective planet gear 10. Each planet gear 10 is in mesh with an annulus gear 12, which is connected to rotate with the output shaft 4. The planet gears 10 are also in mesh with a sun gear 14 mounted to rotate about the axis of the input shaft 2.

The transmission system also includes two electrical machines constituting motor/generators of axial flux type. The first machine comprises a radially extending rotor 16, which is connected to rotate with the sun gear 14 and carries a plurality of magnetic poles at its outer periphery constituted by permanent magnets 18. The rotor 16 cooperates with a stator, which is in two portions on opposite sides of the rotor. The first portion of the stator comprises an annular member 20 including a portion of soft iron 22 carrying a number of electromagnetic coils 24 adapted to create the electric poles of the machine. The other portion of the stator comprises a further annular member 26, which includes further soft iron members 28 on each side, around which the electromagnetic coils 24 also extend. The second electrical machine includes a rotor 32, which is connected to rotate with the annulus gear 12 and again includes a plurality of permanent magnets 34. The rotor 32 cooperates with a further stator, which again comprises two stator members on opposite sides of it. On one side of it is a stator member 36, including a soft iron portion 38, which again carries a number of electromagnetic coils 40. The other stator member is constituted by the stator wall 26, which also constitutes part of the stator of the first machine.

The stator member 26 is connected to be movable to the left or the right, as seen in FIG. 1, by means of three actuators 42, of which only one is shown in FIG. 1 for the sake of clarity. These actuators engage the outer periphery of the stator wall 26 at three equiangularly spaced positions. The actuators 42 may be of any known type, e.g. hydraulic or pneumatic. However, in the present case, they are of mechanical type and include a motor whose output shaft is connected to a threaded shaft 44. This threaded shaft 44 is screwthreadedly received in a complementarily threaded hole in the periphery of the stator wall 26.

The electrical connections of the stators of the two machines are connected together via a controller 45 which is arranged to control the magnitude and direction of power transmitted between the two machines, which will operate as a motor and a generator, respectively. This is described in detail in the prior specifications referred to above and is therefore not illustrated in the drawings and will not be described in any further detail. However, in this case the controller is also connected to control the operation of the actuators 42. If the controller should determine that one of the electrical machines is operating at high speed and low load, from which it necessarily follows that the other machine will be operating at low speed and high load, it transmits an actuating signal to the actuators 42 which then rotate the threaded shafts 44 in a direction which will result in the air gap of that machine which is operating at high speed increasingly, which will necessarily mean that the air gap for the other machine, which is operating at low speed, will reduce. The precise value of the two air gaps, which will of course add up to a constant value, is set by the controller to be appropriate to the speeds/torques of the two machines. As the speed of the one machine decreases, whereby the speed of the other machine will increase, the actuators will be operated to decrease the air gap of the first machine whilst increasing that of the second machine. The two air gaps are constantly modulated in operation to be as close to the optimum values for the instantaneous operating conditions of the two machines as possible.

The movable stator member 26 and the actuators 42 are so arranged that the stator member 26 is movable between a position in which it is in contact with the rotor 18 and a position in which it is in contact with the rotor 34. When the movable stator wall 26 is moved into contact with one or other of the rotors, the permanent magnets on that rotor will attach themselves very strongly to the movable stator wall by virtue of the powerful attraction of the permanent magnets to the soft iron of the stator wall. The rotor in question will then be locked in position. This locking facility is of value if the transmission system is used as the main propulsion system of a vehicle because it can be used to lock the transmission system and thus the vehicle in position thereby supplementing or replacing the conventional hand brake. More significantly, the control system is programmed to detect when the system has reached or is about to reach its node point and the rotor of one or other machine has thus stopped or is about to stop rotating. When this occurs, the controller is programmed to move the movable stator wall 26 to its end position in contact with the rotor in question. This locks the rotor to the stator wall by virtue of magnetic attraction and holds the rotor stationary. The magnetic lock then applies the torque that would otherwise be required to counteract the torque acting on that rotor. The magnetic lock is maintained even after operation of the transmission system has moved to a point at which that machine would have started to rotate again. Under this condition, the transmission system is transmitting power only mechanically and the torque in the output shaft can be varied only by varying the torque applied to the input shaft. However, when operation of the transmission system reaches a point at which the speed of the stationary machine would otherwise have been more than a predetermined amount above zero, the magnetic lock is released and normal operation is then resumed.

The magnetic attraction between the rotor and the movable stator wall is very powerful and it is generally not possible to break the magnetic lock simply by operating the actuators 42. However, the controller is programmed to detect the position of the rotor relative to the stator and this may be effected in a number of ways, for instance by the provision of a Hall-effect sensor on the rotor or by electronically scanning the electric connections of the electromagnetic coils and detecting the effects on them of the permanent magnets. Once the relative position of the rotor has been determined, the controller then calculates the voltages and the phases of electric power to be applied to at least some of the electromagnetic coils sufficient to produce a repulsive force on the rotor of a magnitude great enough to break the magnetic lock. After the necessary voltages have been applied and the magnetic lock broken, normal operation of that machine is immediately resumed.

The permanent magnets which are typically used in electrical machines are so powerful that the magnetic lock produced in accordance with the invention between a rotor and the associated stator will generally be strong enough to resist the torque applied to it when that electrical machine is magnetically locked. However, if it is determined that the torque which will be applied to one or both electrical machines will be very substantial, it may be necessary or desirable to increase the strength of the magnetic lock. This may be readily achieved by additionally programming the control system to determine the angular position of each rotor, when in the locked position, relative to the associated stator and then energising selected electromagnetic coils in the associated stator appropriately to produce an attractive force on the rotor, thereby enhancing the magnetic attraction between the rotor and stator and thus strengthening the lock between them and thus increasing the value of the torque which may be resisted by the magnetic lock.

The second embodiment is very similar structurally and functionally to the embodiment of FIG. 1, but in this case the transmission system is of all electric type and the epicyclic gearset is thus omitted. The input and output shafts 2 and 4 are thus connected directly to the rotors 16 and 32, respectively, of the two machines. The operation of this system is, however, otherwise the same or that of FIG. 1 and it will be seen that, apart from the gearset, FIGS. 1 and 2 are effectively the same.

FIG. 3 shows a modified embodiment in which the epicyclic gearset is of four-branch type. The gearset is in fact of known Ravigneaux type. Since the construction and operation of the gearset itself is well known and the construction and operation of the two electrical machines is substantially the same as that in FIG. 1, it is thought not to be necessary for FIG. 3 to be described in any further detail.

FIG. 4 shows the rotors and stators of a further modified embodiment in which the two electrical machines are of radial rather than axial flux type. The left-hand machine, which will be referred to as the first machine, includes a stator 16 carrying permanent magnet poles 18. The stator 16 is of frusto-conical shape and arranged to rotate about the central axis of the frustum within a complementary frusto-conical space defined by a stator 50 carrying electromagnetic coils 52. The air gap between the rotor and stator is of constant width but is inclined at a shallow angle to the axis of rotation. The second machine is generally similar and includes a rotor 32 carrying permanent magnets 34. The rotor is again of frusto-conical shape and is mounted to rotate about the axis of the frustum within a complementary frusto-conical space defined by a stator 54 including electromagnetic coils 56. The air gap is again of constant width and inclined at a shallow angle to the axis but the angle of inclination is opposite to that of the air gap of the first machine. The two stators 50 and 54 are connected together to form a single composite unit which is connected to one or more actuators (not shown) arranged to move the composite unit to the left or the right parallel to the axis of rotation. If the composite stator unit 50, 54 is moved to the right, as seen in FIG. 4, the air gap of the first machine will increase and that of the second machine will decrease. Conversely, if the composite stator unit is moved to the left, the air gap of the first machine will decrease and that of the first machine will increase. Accordingly, this embodiment can be used in substantially the same manner as the first embodiment in order to adjust the air gaps of the two machines in opposite directions simultaneously so as to optimise the performance of the transmission system. The composite stator unit is again movable so far in the two directions that it may be brought into contact with one or other rotor, thereby locking that rotor in position magnetically. The magnetic lock may again be released in the manner described above.

The embodiment of FIG. 5 is substantially the same as that of FIG. 4, the only difference being that the relative positions of the rotors and stators are reversed. Thus the two rotors 16, 32 define frusto-conical spaces and are mounted to rotate about coincident rotational axes. They carry respective permanent magnet poles 18 and 34 and the directions in which the diameters of the two frusto-conical spaces increase are again opposite to one another. Accommodated within the two rotors are two frusto-conical stators 50, 54, which carry respective electromagnetic coils 50, 56 for producing the electric poles. The stators 50 and 54 are again connected together end to end to form a composite unit and are again connected to one or more actuators to move them in the axial direction. Such movement again causes one of the air gaps to increase and the other simultaneously to decrease.

1. A transmission system of continuously variable transmission ratio including an input shaft, an output shaft, first and second electric motor/generators comprising first and second rotors and first and second stators, respectively, the first and second rotors being connected to rotate with respective shafts and the electrical connections of the first and second stators being connected together, and a controller arranged to control the flow of electrical power between the first and second stators, characterised in that at least a portion of the first stator is connected to at least a portion of the second stator, that the said portion is movable in a first direction, thereby increasing the air gap of the first motor/generator and decreasing the air gap of the second motor/generator, and in a second direction, thereby decreasing the air gap of the first motor/generator and increasing the air gap of the second motor/generator and that an actuator is provided, which is controlled by the controller and is connected to the said portion of the stators to move it selectively in the first or second direction.

2. A system as claimed in claim 1 including a differential gearset comprising at least three parallel shafts, two of which constitute the input shaft and the output shaft, respectively, and all of which carry at least one gearwheel in mesh with at least one gearwheel carried by one of the other shafts.

3. A system as claimed in claim 1 in which the two motor/generators are of radial flux type and the two rotors extend substantially axially and are mounted to rotate about a common axis parallel to the shafts, each stator being of frusto-conical shape and each rotor being of complementary frusto-conical shape, the two stators being connected together and arranged to be movable in the direction of the common axis.

4. A system as claimed in claim 3 in which the two connected stators define respective frusto-conical spaces of decreasing diameter in opposite directions within which the respective complementary rotors are rotatably received.

5. A system as claimed in claim 3 in which the two rotors define respective frusto-conical spaces of decreasing diameter in opposite directions within which the two connected stators are received.

6. A system as claimed in claim 1 in which the two motor/generators are of axial flux type and the two rotors extend radially and are mounted to rotate about a common axis parallel to the shafts, the first stator comprising first and second annular, radially extending stator members on opposite sides of the first rotor and the second stator comprising third and fourth annular, radially extending stator members on opposite sides of the second rotor, the second and third stator members being connected together and constituting a common stator member connected to the actuator.

7. A system as claimed in claim 6 including at least three actuators acting on the common stator member at substantially equiangularly spaced positions.

8. A system as claimed in claim 1 in which the two rotors afford a plurality of magnetic poles constituted by permanent magnets and the said portion of the stators is movable between a first position, in which it is in contact with the first rotor and the first rotor is thus locked to it by the magnetic attraction of the permanent magnets on the first rotor to the said portion of the stators, and a second position, in which it is in contact with the second rotor and the second rotor is thus locked to it by the magnetic attraction of the permanent magnets on the second rotor to the said portion of the stators.

9. A system as claimed in claim 8 in which each stator affords a plurality of magnetic poles created by a plurality of selectively energisable electromagnetic coils and the control system is programmed to determine the angular position of each rotor, when in the locked position, relative to the associated stator and, when it is desired to release the magnetic lock, to energise selected electromagnetic coils in the associated stator appropriately to produce a sufficient repulsive force on the rotor that the magnetic lock is released.

10. A system as claimed in claim 8 in which each stator affords a plurality of magnetic poles created by a plurality of selectively energisable electromagnetic coils and the control system is programmed to determine the angular position of each rotor, when in the locked position, relative to the associated stator and to energise selected electromagnetic coils in the associated stator appropriately to produce an attractive force on the rotor, thereby enhancing the magnetic attraction between the rotor and stator.
